(19) United States
(12) Patent Application Publication
(10) Pub. No.: US 2002/0080393 A1
(43) Pub. Date: Jun. 27, 2002

(54) Parallel printer intercept

(76) Inventor: Ronald A. Leonard, Peculiar, MO (US)

Correspondence Address: THOMAS B. LUEBBERING, HOVEY, WILLIAMS, TIMMONS & COLLINS, Suite 400, 2405 Grand, Kansas City, MO, 64108, US

(21) Appl. No.: 09/880,356

(22) Filed: Jun. 13, 2001

Related U.S. Application Data
(60) Provisional application No. 60/211,130, filed on Jun. 13, 2000.

(51) Int. Cl. G06K 15/02; G06F 3/12; G06F 13/00

(52) U.S. Cl. 358/1.15

(57) ABSTRACT

A printer intercept apparatus (10) operable to monitor communication between a first system (12) and a printer (14), create a second instance of original signals sent therebetween, and forward the second signals to a second system (16), and do so without interfering with communication or data flow between the first system (12) and printer (14).

### RELATED APPLICATIONS

The present application relates to and claims priority with regard to all common subject matter of provisional patent application titled “Parallel Printer Intercept”, Ser. No. 60/211,130, filed Jun. 13, 2000. The identified provisional patent application is hereby incorporated into the present application by reference.

### COMPUTER PROGRAM LISTING APPENDIX

A computer program listing appendix containing the source code of a computer program that may be used with the present invention is incorporated herein by reference and appended hereto as one (1) original compact disk, and an identical copy thereof, containing a total of thirty-four (34) files as follows:

| Date of Creation: | Size (Bytes): | Filename: |
|---|---|---|
| 06/11/01 10:30a | 3,319 | CLK_TICK.C |
| 06/11/01 10:30 a | 3,976 | CRCCHE_1.C |
| 06/11/01 10:30 a | 1,969 | CRCCHE_1.H |
| 06/11/01 10:30 a | 14,694 | DWNLD.C |
| 06/11/01 10:30 a | 2,348 | DWNLD.H |
| 06/11/01 10:30 a | 432 | ERR_CO_1.H |
| 06/11/01 10:30 a | 8,639 | FLASH_1.C |
| 06/11/01 10:30 a | 1,643 | FLASH_1.H |
| 06/11/01 10:30 a | 1,462 | FLASH_2.H |
| 06/11/01 10:30 a | 7,275 | FORMAT.C |
| 06/11/01 10:30 a | 16,676 | INTR.H |
| 06/11/01 10:30 a | 25,730 | MCBSP.H |
| 06/11/01 10:30 a | 3,342 | MY6211.H |
| 06/11/01 10:30 a | 14,771 | PIPX.C |
| 06/11/01 10:30 a | 2,082 | PIPX.H |
| 06/11/01 10:30 a | 8,280 | PPBUF.C |
| 06/11/01 10:30 a | 1,062 | PPBUF.H |
| 06/11/01 10:30 a | 4,353 | RECEIVE.C |
| 06/11/01 10:30 a | 8,818 | REGS.H |
| 06/11/01 10:30 a | 1,374 | RELEASE.H |
| 06/11/01 10:30 a | 2,008 | SEND.C |
| 06/11/01 10:30 a | 13,282 | SERIAL_1.C |
| 06/11/01 10:30 a | 2,722 | SERIAL_1.H |
| 06/11/01 10:30 a | 7,481 | SPPXFC.H |
| 06/11/01 10:30 a | 11,592 | SPPXFC_1.C |
| 06/11/01 10:30 a | 704S | PPXFC_1.H |
| 06/11/01 10:30 a | 8,729 | TCPIP_1.C |
| 06/11/01 10:30 a | 1,873 | TCPIP_1.H |
| 06/11/01 10:30 a | 4,382 | TCPIP_2.C |
| 06/11/01 10:30 a | 13,621 | TIMER.H |
| 06/11/01 10:30 a | 1,474 | TYPES.H |
| 06/11/01 10:30 a | 12,331 | UART_DRV.C |
| 06/11/01 10:30 a | 5,288 | UART_DRV.H |
| 06/11/01 10:30 a | 17,145 | USER_M_1.C |

### BACKGROUND OF THE INVENTION

1. Field of the Invention

The present invention relates to apparatuses for passively collecting and forwarding signals communicated between a first system and a printer. More particularly, the invention relates to an apparatus operable to monitor communication between a first system and a printer, create a second instance of original signals sent therebetween, and forward the second signals to a second system, and do so without interfering with communication or data flow between the first system and printer.

2. Description of the Prior Art

It is often desirable to share data between a first system or application and a second system or application. For example, in a pharmacy setting the first system may be a PC (personal computer) wherein prescription order data is initially entered, and the second system may be a dispensing system with which orders are filled. Unfortunately, there commonly exists no means of interfacing the disparate systems or applications in order to efficiently and conveniently share data therebetween. Often, if manufacturers or providers are unwilling to develop and support a common interface, a user is forced to resort to redundant data entry. In the pharmacy setting, this means that the prescription order data must be inefficiently entered redundantly in both the PC and the dispensing system.

Typically, printer interfaces are network, serial, or parallel in nature. Furthermore, most conventional network printers can be reconfigured to be either serial or parallel printers, and can be connected to a hardware print server, such, for example, a Lantronix EPS2-100. This allows the network printer to maintain a desired degree of flexibility while effectively limiting the number of potential interfaces to two.

Serial printers typically rely on an RS-232 interface to deliver data. RS-232 is an asynchronous protocol utilizing high-accuracy oscillation in both the transmitter and receiver to ensure proper coordination of data transfer between a sending device, such as a PC, and a receiving device, such as printer. When data is transferred through the RS-232 interface a start bit is first sent to synchronize the PC and printer. Thereafter, several bits may be transferred singly as indicated by the oscillators. Because minor differences between the two oscillators could accumulate overtime, the PC and printer are resynchronized with each byte. Flow control lines can be used to prevent transmission of a subsequent byte, though transmission must be allowed to complete once started. Newer PCs have buffering capability and high-speed CPUs allowing serial connection to run without flow control, wherein the printer need only wait for a synchronizing signal and then collect data bits at predefined intervals. The passive nature of this latter operation makes possible in-line connection of a second RS-232 interface also operable to receive data.

Parallel printers typically rely on a Centronix interface or, more recently, an IEEE 1284 interface. These protocols are similar in that they are both synchronous and rely on handshaking each time a piece of data is transferred. Unlike the RS-232 interface, the Centronix and IEEE 1284 interfaces both transmit eight bits simultaneously or parallely rather than singly. In operation, the PC first sets the eight data lines to the desired state. The printer must then read the data and, when finished, set an additional line to indicate that the PC can proceed to the next byte. Because the protocol is driven by handshaking rather than oscillation, it provides the advantage of allowing the PC and printer to communicate as quickly as they are able rather than at some fixed oscillation frequency. Interposing a second Centronix or IEEE-1284 interface in-line with the first to collect data for a second receiving device can create problems, however, because the faster receiving device will attempt to drive the data transfer at a rate higher than the slower receiving device can handle.

Given first and second systems and an RS-232 serial printer, it is possible to fabricate a ‘Y-cable’ to connect the three devices such that any data sent by the first system is received by both the second system and the printer. The same cannot be said where the second system or the printer uses the Centronix/IEEE 1284 standard which dynamically negotiates the data transfer rate. Several mechanisms are available, however, to convert between Centronix/IEEE 1284 data and RS-232 data. These can be combined to create an RS-232 interface that can be split. Unfortunately, certain disadvantages arise, including potential loss of connection integrity; loss of printer reliability; loss of printer performance, and loss of printer functionality. Risk of poor or complete loss of connection integrity increases with each additional in-line connection added. Printer reliability suffers when a serial device interposed between the first system and the printer loses power or otherwise fails, thereby causing the printer to malfunction as well. Printer performance suffers because any scheme that converts parallel data transfer (500-200 Kbytes/sec.) to serial data transfer (115,200 bits/sec. or 14.4 bytes/sec.) creates a substantial bottleneck. Printer functionality may suffer because many off-the-shelf parallel devices function in Compatibility Mode only and effectively eliminate the benefits of IEEE 1284 ECP and EEP communication modes, which may prevent the first PC from exercising some or all of the printer's advanced features.

Due to the above-described and other problems in the art of sharing data between multiple system or applications, a need exists for an improved mechanism for facilitating such data sharing.

### SUMMARY OF THE INVENTION

The present invention solves the above-described and other problems and provides a distinct advance in the art of sharing data between disparate systems or applications. This is accomplished with a printer intercept apparatus operable to monitor communication between a first system and a printer, create a second instance of original signals sent therebetween, and forward the second signals to a second system, and do so without interfering with communication or data flow between the first system and printer.

The preferred apparatus is operatively interposed between a first system, a printer, and a second system, and broadly comprises a first parallel connector; a second parallel connector; a line buffer/driver; a control/data interpreter; a data buffer; a processor; and one or more serial or network interfaces. The first and second parallel connectors couple, respectively, the first system to the apparatus and the apparatus to the printer, forming a parallel passthrough for the original signals through the apparatus. A second instance of the original signals is created by splitting the original signals prior to releasing them. The line buffer/driver buffers the second signals and provides high impedance input of the second signals to the control/data interpreter. The control/data interpreter decodes the second signals according to a predetermined communication mode. The data buffer is temporary storage for the processor. The decoded second signals are input to the processor for processing prior to being sent to the second system via either the serial or network interfaces.

In operation, the apparatus detects, collects, and forwards to the second system second instances of the original signals communicated between the first system and the printer, without interfering with the original communication or data flow. Rather than interfering with byte-by-byte handshaking between the first system and the printer, the apparatus advantageously examines the state of the parallel passthrough at a frequency high enough to ensure that no transmitted data is missed. By interfacing in this manner, the system or application generating the data need only produce a printout thereof to share the data with the second system.

The present invention provides a number of advantages including consolidation of all required features into a single apparatus, thereby limiting to two the number of connections between the first system and the printer. Furthermore, the printer can continue to function even though the apparatus has failed or been turned off because the device uses a non-interfering passive approach to capturing data. Relatedly, the data transfer rate between the first system and the printer is unaffected because the apparatus passively monitors data as it passes through rather than receiving and retransmitting the data. Additionally, printer functionality is unaffected by the apparatus because protocol negotiation is unaffected.

The apparatus of the present invention may be used in any application requiring data sharing between two disparate systems. In the pharmacy setting outlined above, for example, the apparatus may be operatively interposed between the PC and an attached printer such that when the prescription order data is sent as signals from the PC to the printer, as when printing a bill, the apparatus automatically forwards an identical copy of the sent signals to the dispensing system. Thus, the prescription order data need be entered only once, thereby eliminating inefficient redundant data entry.

These and other novel features of the present invention are described in more detail in the section titled DETAILED DESCRIPTION OF A PREFERRED EMBODIMENT, below.

### BRIEF DESCRIPTION OF THE DRAWING FIGURES

The present invention is described in detail below with reference to the attached drawing figures, wherein:

FIG. 1 is a block diagram showing a preferred embodiment of the present invention.

### DETAILED DESCRIPTION OF A PREFERRED EMBODIMENT

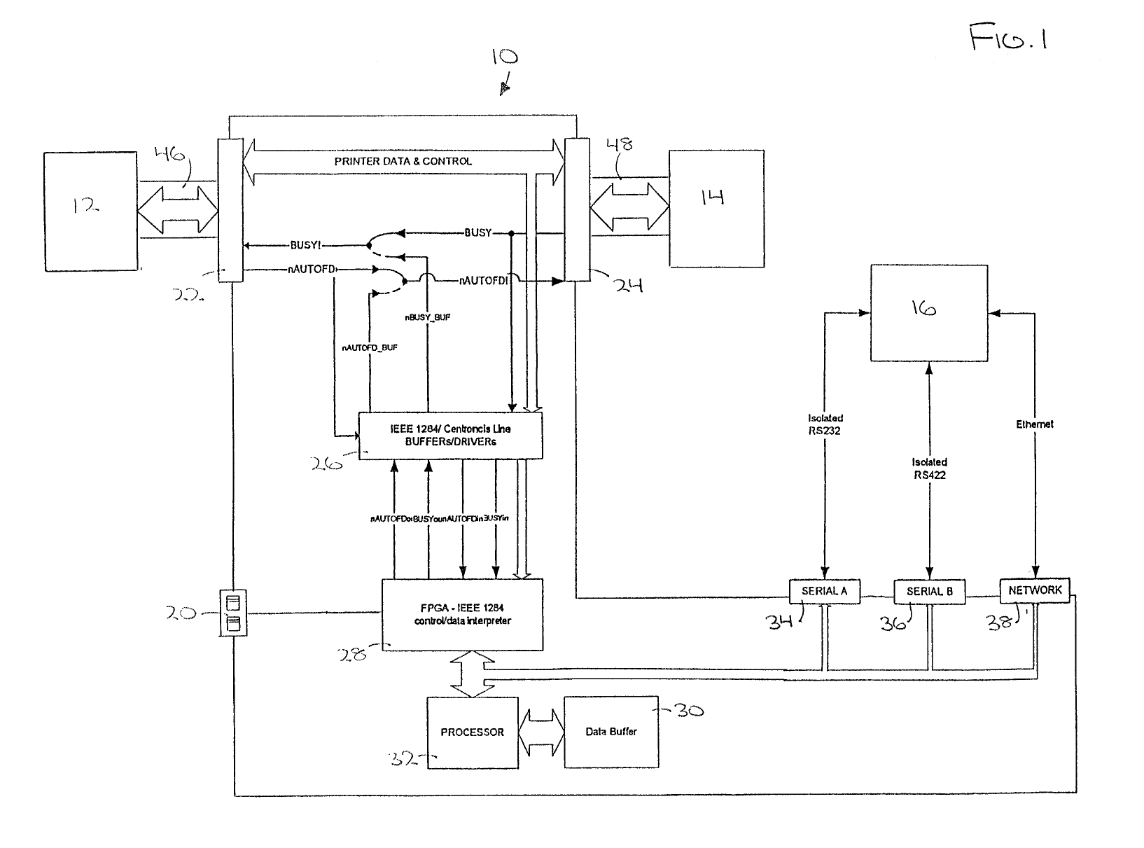

Referring to FIG. 1, a printer intercept apparatus 10 is shown operatively interposed between a first system 12, a printer 14, and a second system 16. The apparatus 10, being constructed in accordance with a preferred embodiment of the present invention, is operable to passively monitor communication and data flow between first system 12 and the printer 14, create second instances of original signals sent therebetween by splitting the original signals to result in the original signals and second signals identical thereto, and provide such second signals to the second system 16 via a serial or network connection. The apparatus 10 operates, for all but the most extreme data transmission rates, without interrupting or otherwise interfering with or affecting the original communication or data flow. For extreme data rates, the apparatus 10 can be easily adapted to pause communication between the first system 12 and the printer 14 without data loss to either the intended recipient or the apparatus 10 itself.

In a preferred embodiment, the printer intercept apparatus 10 broadly comprises a reset button 18; a DIP switch 20; a first parallel connector 22; a second parallel connector 24; a line buffer/driver 26; a control/data interpreter 28; a data buffer 30; a processor 32; an RS232 serial interface 34; an RS422 serial interface 36; and a network interface 38. Additionally, a power-on and a reset indicator (not shown) may be included, wherein the indicators are preferably tell-tale LEDs (light emitting diodes) operable to visually communicate, respectively, a power-on or reset operative status of the apparatus 10.

The reset button 18 is actuatable to cause a power-up reset. A power-up reset is operable in cooperation with the DIP switch 20 to restore default serial communication parameters. Such default parameters include a 9600 baud rate, 7 data bits, no parity bits, and one stop bit.

The DIP switch 44 is preferably a four-position DIP switch operable to cause the apparatus 10 to assume a particular printer communication mode at power-up, wherein the communication mode is determined by the switch settings. More specifically, if the first system 12 or printer 14 are powered-up prior to the apparatus 10, the DIP switch 20 provides input to the control/data interpreter 28 to set the correct IEEE 1284 mode is use. If the apparatus 10 is powered-up first, the control/data interpreter 28 can determine for itself which IEEE 1284 mode is being used.

The first parallel connector 22 is preferably a Centronics connector operable to couple the apparatus 10 with a parallel port (not shown) of the first system 12 via a first parallel printer cable 46. The second parallel connector 24 is preferably a twenty-five pin sub-d connector operable to couple the apparatus 10 with the printer 14 via a second parallel printer cable 48. The first and second parallel connectors 22, 24 cooperate to provide a parallel passthrough for the original signals through the apparatus 10.

The line buffer/driver 26 is preferably an IEEE 1284 line buffer/driver providing 64 Megabytes of buffer storage and high impedance input of the control and data signals into the printer intercept apparatus 10. The buffer/driver's buffer capacity is selected to be larger than the any potential intended recipient's buffer capacity, thereby preventing bottleneck problems. Additionally, when the apparatus 10 is optionally configured to provide IEEE 1284 flow control, the line buffer/driver 26 drives an nAUTOFD control signal to the printer 14 and a BUSY control signal to the first system 12 from the control data/interpreter 28. The nAUTOFD control signal is generated by the first system 12 for benefit of the printer 14, wherein a logic low tells the printer 14 to automatically generate a line feed after it receives a carriage return from the first system 12. The BUSY control signal is generated by the printer 14 for benefit of the first system 12, wherein a logic high indicates that the printer 14 is ready to accept more data. As will be appreciated by one with ordinary skill in the computer arts, additional or alternative control signals may also be used.

The control/data interpreter 28 is preferably an FPGA IEEE 1284 control/data interpreter responsible for decoding various IEEE 1284 communication modes and providing the resulting information and IEEE 1284 data on demand to the processor 32. That is, the interpreter 28 decodes or formats the second signals according to a predetermined communication mode, wherein the appropriate communication mode is determined, as described above, either by the DIP switch settings or by the interpreter 28 itself. IEEE 1284 communication modes include Compatibility Mode, Nibble Mode, Byte Mode, EPP, and ECP.

The data buffer 30 is a read/write storage element for storing processor data or IEEE 1284 control/data for internal processing or for temporary storage until the data can be sent to or used by the processor 32 or second system 16. The data buffer 30 is preferably 128Meg RAM (random access memory), but may alternatively be any suitable memory mechanism.

The processor 32 controls overall operation of the printer intercept apparatus 10. The processor 32 may, as needed, buffer the collected control and data signals in the data buffer 30 for internal processing or for forwarding to the second system 16. A computer program listing appendix is hereto appended containing source code for use in cooperation with the processor 32 in controlling operation of the apparatus 10. Processor performance is important, particularly with regard to its ability to process data, so as not to adversely affect data flow between the first system 12 and printer 14. A suitable VLIW DSP processor is available from Texas Instruments, model number TMS320C671 1, though a variety of suitable alternative processors may be used.

The RS232 serial interface 34 provides a 1500V isolated RS232 connection to the second system 16, wherein the second system 16 is in close proximity (approximately thirty feet) to the printer intercept apparatus 10. The RS422 serial interface 36 provides a 1500V optically-isolated RS422 connection for baud rates up to 115.2Kbytes to the second system, wherein the second system 16 is remote (up to approximately 5000 feet) from the printer intercept apparatus 10. The network interface 38 is preferably 10 base-T/1000 base-T LAN connection connecting the printer intercept apparatus 10 to the second system 16 via a LAN (local area network).

In operation, the apparatus 10 is operatively interposed between the first system 12, the printer 14, and the second system 16. In a pharmacy setting, for example, the first system 12 may be a personal computer (PC); and the second system 16 may be a dispensing system, such as, for example, an SP200 dispensing system, manufactured by ScriptPro LLC. Rather than redundantly entering data into both the first system 12 and the second system 16, the apparatus 10 passively creates second instances of original signals sent between the first system 12 and the printer 14, processes the second signals if necessary, and then forwards them to the second system 16. Thus, in the pharmacy setting example, prescription order data may be entered into the first system 12 and, when the order data is sent to the printer 14 to generate a corresponding bill or report, forwarded automatically to the dispensing system 16 for filling.

The apparatus 10 passively monitors all pins of the parallel connector 46 in order to detect original control or data signals sent between the first system 12 and the printer 14. Rather than interfering with byte-by-byte handshaking between the first system 12 and the printer 14, the apparatus 10 advantageously examines or samples the state of the parallel pass-through at a frequency high enough to ensure that no transmitted data is missed. For IEEE 1284 compliant systems, for example, a sampling rate of 2MB per second is sufficient; for other systems, the sampling rate may be decreased or increased as needed. Detected signals are split as they pass through the apparatus 10, thereby resulting in the original signals and second instances thereof. The second signals are then processed by the processor 32 and stored, if necessary, in the data buffer 30, and thereafter forwarded to the second system 16 via either the RS-232 serial interface 34, the RS-422 serial interface 36, or the network connection 38, as appropriate.

Although the invention has been described with reference to the preferred embodiment illustrated in the attached drawing figures, it is noted that equivalents may be employed and substitutions made herein without departing from the scope of the invention as recited in the claims. Those with skill in the art will appreciate that numerous different embodiments of hardware, software, firmware or combinations thereof exist for practicing the present invention. For example, as noted, the buffer/driver 26, control/data interpreter 28, data buffer 30 and processor 32 may be any devices suitable for performing the functions described herein, and are not limited to the disclosed examples. Accordingly, the present invention should not be viewed as limited to the particular illustrative embodiment shown and described.

Having thus described the preferred embodiment of the invention, what is claimed as new and desired to be protected by Letters Patent includes the following:

1. A printer intercept apparatus interposed between a first system and a printer and operable to create a second signal which is identical to an original signal sent between the first system and the printer and to forward the second signal to a second system, the printer intercept apparatus comprising:
a parallel passthrough operable at a first end to receive the original signal and operable at a second end to release the original signal, wherein the first end is coupled with the first system and the second end is coupled with the printer;
an apparatus buffer operable to store the second signal; and
an interface operable to couple the apparatus buffer and the second system and to deliver the second signal to the second system.

2. The printer intercept apparatus as set forth in claim 1, wherein the parallel passthrough includes a first parallel connector at the first end and a second parallel connector at the second end.

3. The printer intercept apparatus as set forth in claim 1, wherein the printer includes a printer buffer having a print buffer capacity and the apparatus buffer is selected to have an apparatus buffer capacity greater than the print buffer capacity.

4. The printer intercept apparatus as set forth in claim 1, wherein the interface is an RS-232 serial interface.

5. The printer apparatus as set forth in claim 1, wherein the interface is an RS-422 serial interface.

6. The printer intercept apparatus as set forth in claim 1, wherein the interface is an optically isolated interface.

7. The printer intercept apparatus as set forth in claim 1, wherein the interface is a network interface.

8. The printer intercept apparatus as set forth in claim 1, wherein the first system is a personal computer.

9. The printer intercept apparatus as set forth in claim 1, wherein the second system is a medication dispensing unit.

10. The printer intercept apparatus as set forth in claim 1, further including an interpreter operable to decode the second signal according to a predetermined communication mode prior to delivering the second signal to the second system.

11. The print intercept apparatus as set forth in claim 10, wherein the predetermined communication mode is selected from the group consisting of: Compatibility Mode, Nibble Mode, Byte Mode, EPP, and ECP.

12. The print intercept apparatus as set forth in claim 1, further including a processor operable to process the second signal prior to delivering the second signal to the second system.

13. A printer intercept apparatus interposed between a first system and a printer and operable to create a second signal which is identical to an original signal sent between the first system and the printer and to forward the second signal to a second system, the printer intercept apparatus comprising:
a parallel passthrough operable at a first end to receive the original signal and operable at a second end to release the original signal, wherein the first end is coupled with the first system and the second end is coupled with the printer;
an apparatus buffer operable to collect the second signal and to provide a high impedance input of the second signal;
an interpreter operable to receive the second signal from the buffer/driver and to decode the second signal according to a predetermined communication mode;
a processor operable to receive the second signal after decoding and to process the second signal for use by the second system; and
an interface operable to couple with the second system and to deliver the second signal to the second system following processing by the processor.

14. The printer intercept apparatus as set forth in claim 13, wherein the parallel passthrough includes a first parallel connector at the first end and a second parallel connector at the second end.

15. The printer intercept apparatus as set forth in claim 13, wherein the printer includes a printer buffer having a print buffer capacity and the apparatus buffer is selected to have an apparatus buffer capacity greater than the print buffer capacity.

16. The print intercept apparatus as set forth in claim 13, wherein the interface is an RS-232 serial interface.

17. The print apparatus as set forth in claim 13, wherein the interface is an RS-422 serial interface.

18. The print intercept apparatus as set forth in claim 13, wherein the interface is an optically isolated interface.

19. The print intercept apparatus as set forth in claim 13, wherein the interface is a network interface.

20. The print intercept apparatus as set forth in claim 13, wherein the predetermined communication mode is selected from the group consisting of:
Compatibility Mode, Nibble Mode, Byte Mode, EPP, and ECP.

21. The printer intercept apparatus as set forth in claim 13, wherein the first system is a personal computer.

22. The printer intercept apparatus as set forth in claim 13, wherein the second system is a medication dispensing unit.

23. A printer intercept apparatus interposed between a first system and a printer and operable to create a second signal which is identical to an original signal sent between the first system and the printer and to forward the second signal to a second system, the printer intercept apparatus comprising:
a first connection coupled with the first system and operable to receive the original signal;
a second connection coupled with the printer and operable to release the original signal;
an apparatus buffer interposed between the first and second connections and operable to collect the second signal and to provide a high impedance input of the second signal;
an interpreter operable to receive the second signal from the buffer/driver and to decode the second signal according to a predetermined communication mode;
a processor operable to receive the second signal after decoding and to process the second signal for use by the second system; and
an interface coupled with the second system and operable to deliver the second signal to the second system following processing by the processor.

24. The printer intercept apparatus as set forth in claim 23, wherein the printer includes a printer buffer having a print buffer capacity and the apparatus buffer is selected to have an apparatus buffer capacity greater than the print buffer capacity.

25. The print intercept apparatus as set forth in claim 23, wherein the interface is an RS-232 serial interface.

26. The print apparatus as set forth in claim 23, wherein the interface is an RS-422 serial interface.

27. The print intercept apparatus as set forth in claim 23, wherein the interface is an optically isolated interface.

28. The print intercept apparatus as set forth in claim 23, wherein the interface is a network interface.

29. The print intercept apparatus as set forth in claim 23, wherein the predetermined communication mode is selected from the group consisting of:
Compatibility Mode, Nibble Mode, Byte Mode, EPP, and ECP.

30. The printer intercept apparatus as set forth in claim 23, wherein the first system is a personal computer.

31. The printer intercept apparatus as set forth in claim 23, wherein the second system is a medication dispensing unit.
